(19) United States
(12) Patent Application Publication
(10) Pub. No.: US 2007/0028669 A1
(43) Pub. Date: Feb. 8, 2007

(54) Detection of contaminants within fluid pumped by a vacuum pump

(76) Inventor: Barrie Dudley Brewster, East Sussex (GB)

Correspondence Address: THE BOC GROUP, INC., 575 MOUNTAIN AVENUE, MURRAY HILL, NJ, 07974-2064, US

(21) Appl. No.: 10/572,890

(22) PCT Filed: Sep. 16, 2004
(86) PCT No.: PCT/GB04/03983

§ 371 Date: Mar. 20, 2006

(30) Foreign Application Priority Data
Sep. 26, 2003 (GB) 0322609.9
Apr. 26, 2004 (GB) 0409275.5

(51) Int. Cl. G01N 1/24

(52) U.S. Cl. 73/31.03

(57) ABSTRACT

A vacuum pump has, in fluid communication with a location intermediate an inlet thereof for receiving fluid and an outlet thereof for exhausting pumped fluid, a sensor for receiving at least part of the fluid received by the pump and for sensing the presence of one or more contaminants therein.

This invention relates to the detection of contaminants within fluid pumped by a vacuum pump and, in particular, by a molecular vacuum pump.

Many manufacturing processes and experiments are highly sensitive to contamination, and for this reason are conducted within a vacuum, or a partial vacuum environment. In particular certain fabrication processes in the manufacture of semiconductor devices, such as etching, deposition, and ion implantation require vacuum conditions to ensure the chemical purity of the process, as well as to obtain the correct physical conditions (molecular mean free path, etc) suitable for creating a reactive plasma or providing a uniform process. More recently, Extreme Ultra Violet (EUV) projection lithography processes have been devised, in which the reflective surfaces of optical components are highly sensitive to damage in the presence of water or hydrocarbon contamination.

In order to ensure the environmental conditions for such sensitive vacuum processes, it is highly advantageous to have a partial pressure sensing device capable of distinguishing contaminant gas species from the other gases intentionally introduced into the vacuum chamber. These other gases may be reactive gases, or inert gases required to create the necessary pressure and flow conditions.

A number of methods exist in the prior art for species selective gas pressure measurement.

(1). Residual Gas Analyser (RGA)

In the prior art, partial pressure analysers are used to measure the constituents of gas in a vacuum chamber. Such RGAs are typically Quadrupole Mass Spectrometers (QMS), which are costly, and generally only capable of measuring at low levels of total pressure. In this method a spectrum is produced, corresponding to a partial pressure of ions present as a function of their mass-to-charge ratio (m/z). In general, gas molecules present in the system are cracked in the ion source, yielding smaller ions which appear in the spectrum at generally lower m/z values.

(2). Sampling Residual Gas Analyser

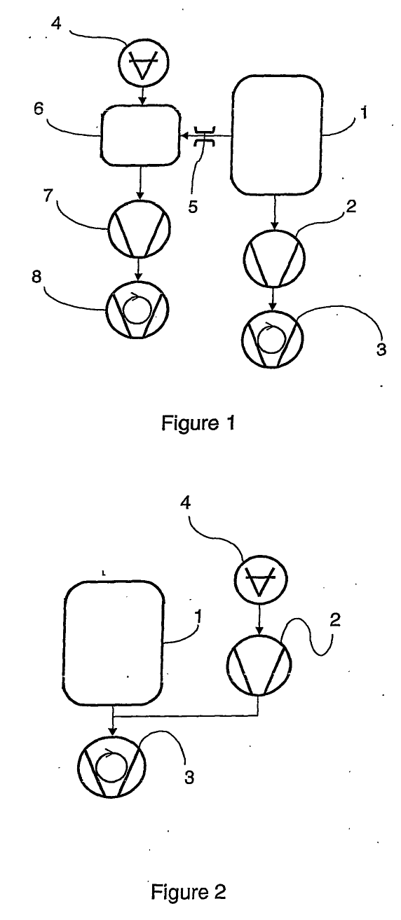

FIG. 1 illustrates an arrangement where the total pressures exceed the levels allowed by the pressure sensing device. A chamber 1 is pumped by pump 2, typically a turbo-molecular pump 2, and backing pump 3, typically a positive displacement pump. An RGA 4 is connected to an auxiliary chamber 6, which is connected to chamber 1 via a flow-restricting device 5. The auxiliary chamber 6 is equipped with an additional molecular pump 7 and positive displacement pump 8, which allows the RGA 4 to operate at an acceptable level of total pressure. Such a system allows the measurement of gas species which are most abundant in the chamber (1), but is unable to measure gas species which have very low partial pressures; typically measurements are limited to relative levels of the order of 50 parts per billion. The additional pumping arrangement of molecular pump 7 and positive displacement pump 8 also leads to-a very costly system.

(3). Transient Residual Gas Analyser

In order to measure oil backstreaming from a pumping arrangement, it is known to connect an RGA to a vacuum chamber upstream of the pump arrangement. Once the system has reached ultimate pressure, the RGA is switched off, allowing the nearby surfaces of the chamber to cool and so adsorb oil vapours present in the chamber. When the RGA is again switched on, the accompanying rise in temperature causes rapid desorption of vapours, which are detected in the RGA. This results in a highly amplified “spike” of detected vapour, which then decays as thermal equilibrium is re-established. This amplified response may be used to improve the sensitivity of the measuring system.

(4). Contraflow Residual Gas Analyser

As illustrated in FIG. 2, an alternative method (often applied in Helium Leak Detection) is to connect the RGA in a contraflow configuration. In this arrangement, the RGA 4 is connected to the inlet of a molecular pump 2. The outlet of the pump 2 is connected to a positive displacement pump 3, which is also connected to the chamber 1. Whilst the molecular pump 2 maintains the RGA 4 at a sufficiently low total pressure, helium is allowed to flow backwards through the molecular pump 2, and so the arrangement relies on the fact that the compression ratio of the molecular pump 2 is low for certain gas species, particularly light gases such as helium.

This arrangement provides improvements in the relative sensitivity of the RGA for gases such as helium, but is unsuitable for other gases, such as water vapour or hydrocarbons. Because the sensitivity of the device for each gas species is dependent on the compression ratio of the molecular pump for that particular species, the system is unsuitable for use as a multi-gas analyser. The method is effective for helium because molecular pumps have a poor compression ratio for helium, whereas it is ineffective for most heavy hydrocarbon contaminants because molecular pumps exhibit high compression ratios for these heavy molecules. The high cost of the analyser and the additional pump 2 is also disadvantageous.

(5). Pump-Assisted Leak Detection

When helium leak detection is used on large vacuum systems having their own vacuum pumps, the speed of response may be improved by attaching a helium leak detector to the foreline of the vacuum pumps, rather than directly to the vacuum chamber. The speed of response in leak detection is related to the ratio S/V, where S is the pumping speed of the leak detection system, and V is the volume of the vacuum chamber. Most leak detectors have low pumping speeds, in the region of a few litres/second, and so for a large vacuum chamber, with correspondingly larger vacuum pumps, the effective pumping speed of the leak detector is greatly increased by connecting it in series with these large vacuum pumps. Whilst this method is highly advantageous for helium leak detection, it is not practical for the detection of hydrocarbon contamination in the chamber, because of the high concentration of hydrocarbon contamination usually present in the foreline (often caused by the backing pumps).

(6). GC-MS inlet Concentrator

In Gas Chromatography Mass Spectroscopy (GC-MS), the gas to be analysed may be detected by a variety of techniques, including a quadrupole analyser, time-of-flight (TOF) and other methods. In order to increase the sensitivity of such methods, an “Inlet Concentrator” is sometimes used, otherwise known as a “Purge and Vent” device. These devices comprise a small chamber, filled with adsorbent material such as activated charcoal, whose temperature may be varied. The device is exposed to the gas to be analysed, and then rapidly heated, driving off all the accumulated gas in a short time. The increased concentration improves the sensitivity of the detecting device.

(7). Temperature Programmed Desorption Spectroscopy (TPDS)

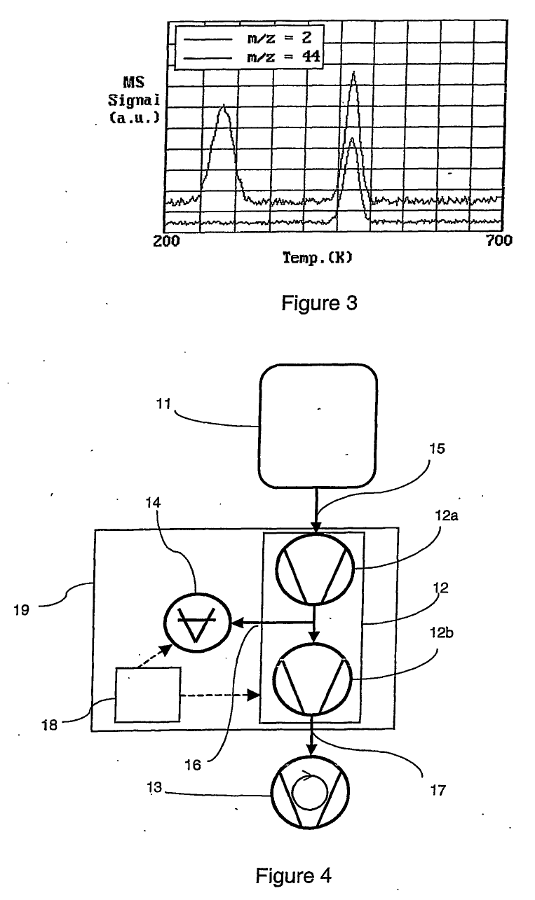

In this analytical method, the gas is adsorbed onto an adsorbate layer held at a low temperature, and then the temperature is increased at a steady controlled rate (typically a few K/s). The gases so driven off are then detected with a suitable detector, such as a Quadrupole Mass Spectrometer (QMS), although Time of Flight (TOF) spectrometry can also be used. This method provides a spectrum of gas pressure as a function of temperature, which may be interpreted to indicate the relative abundance of gases with different binding energies to the surface, so providing valuable information on the constituents of the gas. For example, in FIG. 3, the QMS output is shown for formic acid adsorbed onto a copper substrate for atomic mass values m/z=2 and 44. This shows only weakly-absorbed hydrogen (m/z=2) desorbed at around 280K, and both Hydrogen and Carbon Dioxide (m/z=44) desorbed at around 470K.

(8). Gas Selective Capacitative Measuring Device

An alternative solution is to use a gas selective measuring device, such as a capacitative sensor in which a dielectric material, often a thin-film polymer, changes properties in response to the presence of water vapour. Such devices have the disadvantage that they are only sensitive to a particular gas species (in this example water vapour), and also they generally have a lower absolute sensitivity. They are also susceptible to drift. However, because they are only sensitive to a particular gas species, they are capable of measuring at low relative partial pressures, where the species of interest is a small fraction of the other gases present. They have the further advantage of lower cost than residual gas analysers.

(9). Quartz Crystal Microbalance (QCM)

These devices rely on measuring the mass of contamination adsorbed (condensed) onto the surface of the device. The device comprises a quartz crystal, excited by a high frequency electrical voltage, whose natural frequency is affected by the additional mass caused by the adsorbed material. These devices are species dependent, since they respond only to gases, which condense on their surface, and their ability to distinguish gases may be modified by coating their surface with suitable materials, or by operating the device at different temperatures, including cryogenic temperatures.

(10). Surface Acoustic Wave (SAW) Sensors

These devices are similar to QCMs, but rely on waves propagated on the surface of the device, rather than on waves travelling through its bulk. This greatly improves their sensitivity to small amounts of material adsorbed on their surface.

(11). Metal-Oxide Conductance Sensors

These devices use a thin layer of metal oxide, usually deposited by Chemical Vapour Deposition (CVD), to generate a sensing layer whose electrical conductivity is sensitive to adsorbed materials. Special fabrication techniques allow arrays of such thin film devices to be deposited onto a single substrate, each sensitive to a particular group of materials. Since these devices depend on oxidation, they are susceptible to drift in a vacuum environment, which is oxygen reducing.

(12). Solid State Electrochemical Cell

These sensors comprise a solid electrolyte, between two electrodes, and rely on detecting currents carried by or voltages generated by oxygen anions. These are suitable for measuring hydrocarbon contamination, but have a detection limit which is higher than is required in many applications. They must also be operated at elevated temperatures in order to promote anion conduction. In some circumstances, the electrolyte allows diffusion of oxygen from the atmosphere into the vacuum system, which may itself become a source of process contamination. These prior art methods (1) to (12) discussed above have various disadvantages which render them unsuitable for use as a method for quantitative measurement of partial pressures in a process application.

(A). Cost

Prior art methods (1) to (7) generally rely on quadrupole mass analysers or similar costly detection devices. In most cases they also require auxiliary vacuum chambers with their own vacuum pumping equipment. The cost of such systems is often too great to be suitable for widespread use in many processes.

(B). Interpretation

Quadrupole mass spectrometer data is complex to interpret, since large hydrocarbon molecules are cracked in the ion source, and interpretation requires a skilled operator to determine the parent chemical from the cracking pattern of lighter fragments. This makes it unsuitable for automated process control software.

(C). Sensitivity

RGAs have difficulty in resolving small partial pressures against a background of other benign gas. In particular, it is difficult to detect water against a large background of argon, since double-ionised argon appears at 20 amu, and water at 18. Also, cracked hydrocarbons yield fragments C₃H₄⁺(40 amu) and other fragments close in mass to 40 amu. These are also difficult to resolve in the presence of argon. Argon is frequently used in both semiconductor fabrication processes and EUV lithography tools. The lower cost sensors (8) to (11) do not suffer the same disadvantage of being affected by other gases, but generally have poor sensitivity.

(D). Speed of Response

The speed of response of the sampling residual gas analyser of prior art method (2) is poor, because, with reference back to FIG. 1, the flow-restricting device 5 limits the rate at which the contaminant enters the auxiliary chamber 6.

(E). Effect on the Vacuum System

Prior art methods (6) and (7) involve temperature modulation, and are generally used for analytical purposes only to determine the relative concentrations of different species. They are generally considered unsuitable for quantitative measurement of partial pressures in a process application, because the fluctuations in temperature cause increased concentrations of contaminants, which adversely affect the process. In general the increase in sensitivity provided by such temperature modulation is governed by the “mark-space ratio” —the ratio of the time for which the surface is heated compared with the time for which it is kept cool.

(F) Thermal Radiation and Conduction

The RGA, and also the Solid State Electrochemical cell, must be operated at elevated temperatures, which transmit heat into the vacuum system by conduction or radiation. This may be very detrimental in lithography or metrology systems, which are very susceptible to temperature variations.

(G) Charged Particles

The RGA typically generates energetic charged particles (ions or electrons) which may also be harmful to the process

(H) Generated Contamination

Some sensors also generate contamination. In the case of the Solid State electrochemical cell, diffusion of oxygen from the atmosphere may contaminate the process.

In summary, because contaminants may damage extremely expensive components, it is important that sensing device is very sensitive to low levels of contamination, and also has a fast response time so that adequate protection may be provided by process control software.

In a first aspect, the present invention provides apparatus comprising a vacuum pump having an inlet for receiving fluid and an outlet for exhausting pumped fluid, and, in fluid communication with a location intermediate the inlet and the outlet, a sensor for receiving at least part of the fluid received by the pump and for detecting the presence of one or more contaminants therein.

Thus, a sensor for detecting the presence of one or more contaminants is provided intermediate the pump inlet and the pump outlet. Accordingly, the partial pressure of the or each contaminant detected by the sensor is dominated by the flow of fluid received by the pump inlet, and so any backstreaming from a backing pump connected to the pump outlet has minimal affect on the partial pressure of the contaminants.

Preferably, the pump comprises at least a first and a second pumping stage, and said location is located between the first and second stages. Sensitivity of the sensor can be increased by operating the sensor at a location where the contaminants within the received fluid have been compressed to a higher partial pressure by the first pumping stage of the pump. For instance, if the pumping speed of the first stage is Sₐ, and that of the second stage is S_{b}, then the contaminant partial pressure at the sensor, pₛ, is related to the partial pressure in the chamber, p_{c}, by the expression pₛ=p_{c}×Sₐ/S_{b}. Furthermore, the pumping effect of the second stage ensures that the sensor is unaffected by contaminants present in the foreline.

One of the stages preferably comprises a molecular stage. For example, one of the stages may comprise a turbo-molecular stage, and/or one of the stages may comprise a molecular drag stage.

The sensor is preferably connected externally of the pump, in which case the pump comprises at said location a port, the apparatus comprising means for conveying fluid from said port towards the sensor. The apparatus preferably includes a housing for housing both the pump and the sensor. Control means may be provided for controlling both the pump and the sensor, the control means being preferably housed within a common housing,

Preferably, in use the sensor is sensitive to contaminants (such as water vapour or hydrocarbons) in the fluid substantially independent of the pressure of non-contaminants in the fluid. The sensor is preferably sensitive to one or more selected contaminants only, which can render the signal output from the sensor easier to interpret and process using automated process control software. Preferably, the sensor is arranged to provide an output which is indicative of the partial pressure of the contaminants with the fluid.

The sensor may be a quartz crystal microbalance sensor, a surface acoustic wave sensor, or a capacitive-type sensor.

In one embodiment, the sensor is combined with an inlet concentrator to increase its sensitivity, or to improve its ability to discriminate between different gas species. The temperature modulation in the inlet concentrator may be substantially of a stepwise form, which can allow accumulation of contaminants while the surface is at a lower temperature, and to rapidly desorb these accumulated contaminants as the temperature is rapidly increased, thus creating a large transient concentration of contaminant, which may be easily sensed.

Alternatively, the temperature modulation may be substantially of a saw-tooth form, which can allow contaminants to accumulate at the lower temperature, and desorb more slowly as the temperature is progressively increased, so that contaminants having lower binding energy are desorbed at the lower temperatures, and those with a higher binding energy at the higher temperatures, thus providing the ability to discriminate between contaminants of different binding energies. In another alternative, the temperature modulation may be substantially of a ramped-pulsed form.

The sensor may comprise a surface coated with material for absorbing one or more of the contaminants. Means for cooling the sensor to a temperature below ambient temperature may be provided, which can improve the ability of the sensor to absorb the contaminants of interest.

The apparatus preferably comprises a backing pump connected to the pump outlet for pumping fluid exhaust from the vacuum pump. The inlet may be in fluid communication with a vacuum chamber for receiving fluid therefrom.

Apparatus according to any preceding claim, wherein the contaminants comprise at least one of water and a hydrocarbon.

The present invention also provides, in combination, a vacuum pump having an inlet for receiving fluid and an outlet for exhausting pumped fluid, and a sensor, in fluid communication with a location intermediate the inlet and the outlet, for receiving at least part of the fluid received by the pump and for detecting the presence of one or more contaminants therein.

The present invention further provides a method of detecting the presence of one or more contaminants within pumped fluid, comprising receiving fluid at an inlet of a vacuum pump; and conveying, from a location intermediate the inlet and an outlet of the vacuum pump, at least part of the fluid received by the pump to a sensor for detecting the presence of one or more contaminants therein.

Features relating to apparatus aspects of the invention are equally applicable to method aspects of the invention, and vice versa.

Preferred features of the present invention will now be described, by way of example only, with reference to the accompanying drawings, in which:

FIG. 1 illustrates an arrangement of a sampling residual gas analyser;

FIG. 2 illustrates an arrangement of a contraflow residual gas analyser;

FIG. 3 is a graph showing the desorption spectrum of adsorbed formic acid;

FIG. 4 illustrates an embodiment of the present invention; and

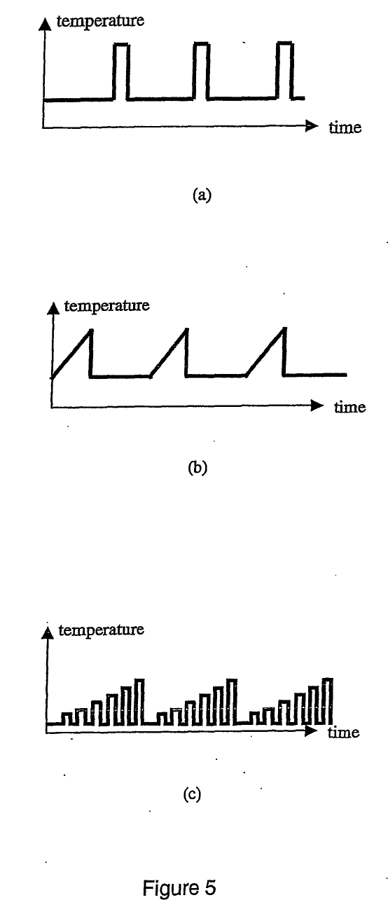

FIGS. 5(a) to (c) illustrate various forms of temperature modulation which could be applied to the sensor of FIG. 4.

With reference to FIG. 4, a pump 12, such as a turbomolecular, molecular drag, or a compound turbomolecular/molecular drag pump has an inlet 15 connected to a vacuum chamber 11 by an inlet pipe or duct, and an outlet 17 connected to a second vacuum pump 13, such as a dry backing pump, by an outlet pipe or duct. The pump 12 has a first pumping section 12a, and a second pumping section 12b. The first pumping section 12a comprises at least one pumping stage, for example at least one turbomolecular stage, and the second pumping section 12b comprises at least one pumping stage, for example at least one molecular drag stage.

A partial pressure sensor, or measuring device, 14 is connected to a port of the molecular pump located intermediate the pump inlet 15 and the pump outlet 17 by a connecting pipe or duct 16. The partial pressure measuring device 14 may be a QCM (Quartz Crystal Microbalance), SAW (Surface Acoustic Wave) or a capacitive type (or similar gas-specific sensor), and may also use temperature modulation to increase its sensitivity, or to improve its ability to discriminate between different gas species. As illustrated in FIG. 4, a controller 18 may be provided for controlling both the pump 12 and the partial pressure measuring device 14, with the pump 12, partial pressure measuring device 14 and controller 18 preferably being located in a common housing 19.

The temperature modulation may be substantially stepwise as in FIG. 5(a), may be substantially of a sawtooth form as in FIG. 5(b) or substantially of a ramped pulse form as in FIG. 5(c). The effect of a stepwise modulation is to allow accumulation of contaminants while the surface is at a lower temperature, and to rapidly desorb these accumulated contaminants as the temperature is rapidly increased, thus creating a large transient concentration of contaminant, which may be easily sensed. The effect of the sawtooth modulation is to accumulate contaminants at the lower temperature, and then desorb them more slowly as the temperature is progressively increased, so that contaminants having lower binding energy are desorbed at the lower temperatures, and those with a higher binding energy at the higher temperatures, thus providing the ability to discriminate between contaminants of different binding energies.

In use, contaminant gases present in the chamber 11 are pumped by the pumping section 12a closest to the pump inlet, and compressed by that pumping section 12a to a higher pressure. By this means the pressure of the contaminant gas is increased to enable the contaminant to be more easily detected by the partial pressure measuring device 14.

It is also likely that contaminant gases are present in the vicinity of the outlet duct 17 of the pump 12, as a result of contaminants present in its bearing and lubrication system, or its motor driving system, or as a result of contaminants present in the second vacuum pump 14. Normally these contaminants do not affect the process chamber 11, because the pumping sections 12a, 12b provide an effective barrier against these contaminants. However it is important that the partial pressure measuring device 14 does not respond to increases in. contaminants in the outlet duct. This is ensured by the pumping effect of the pumping section 12b adjacent to the outlet duct 17.

There are thus a number of distinct advantages of the present invention over the prior art methods (1) to (12) described above.

(A). Cost

The invention overcomes the cost disadvantages of the Residual Gas Analyser, by using a lower cost gas-selective measuring device. No additional pumping means are required where the invention is applied to vacuum systems which already use a molecular pump. The absolute sensitivity of the gas-selective measuring device is improved by connecting the device at a point in the system where the total pressure is high.

(B). Interpretation

The output from a sensor which is only sensitive to the contaminants of interest is intrinsically easier to interpret and process using automated process control software.

(C). Sensitivity

The invention increases the sensitivity of the sensor by operating the sensor in a region where the contaminants present in the vacuum chamber have been compressed to a higher partial pressure. If the pumping speed of the pumping section 12a of the pump 12 is Sₐ, and that of the pumping section 12b of the pump 12 is S_{b}, then the contaminant partial pressure at the sensor, pₛ, is related to the partial pressure in the chamber, p_{c}, by the expression pₛ=p_{c}×Sₐ/S_{b}. Furthermore, the pumping effect of the pumping section 12a of the pump 12 ensures that the sensor is unaffected by contaminants present in the foreline.

(D). Speed of Response

The speed of response is improved by using the pumping speed of the first section 12a of the pump 12 to pump contaminants into the sensor.

(E). Effect on the Vacuum System

The pumping effect of the first section 12a of the molecular pump 12 prevents the process chamber 11 from being adversely affected by fluctuations in contaminant pressures caused by the temperature modulation. It also insulates the process chamber from contaminants generated by the sensor itself

(F). Thermal Effect

Since the sensor is located remote from the process chamber, thermal effects resulting from radiation or conduction from either the sensor itself, or from temperature modulation in an inlet concentrator, are greatly reduced.

In summary, a vacuum pump has, in fluid communication with a location intermediate an inlet thereof for receiving fluid and an outlet thereof for exhausting pumped fluid, a sensor for receiving at least part of the fluid received by the pump and for sensing the presence of one or more contaminants therein.

1. Apparatus for detecting contaminants within a fluid pumped by a vacuum pump comprising:
pumping means having an inlet for receiving fluid and an outlet for exhausting pumped fluid;
a sensor in fluid communication with a location intermediate the inlet and the outlet for receiving at least part of the fluid received by the pumping means and for detecting the presence of one or more contaminants therein.

2. The apparatus according to claim 1 wherein the pumping means comprises at least a first and a second pumping stage, and the location is located between the first and second stages.

3. The apparatus according to claim 2 wherein one of the stages comprises a molecular stage.

4. The apparatus according to claim 2 wherein one of the stages comprises a turbo-molecular stage.

5. The apparatus according to any of claims 2 wherein one of the stages comprises a molecular drag stage.

6. The apparatus according to claim 1 wherein the pumping means comprises at the location a port, the apparatus comprising means for conveying fluid from the port towards the sensor.

7. The apparatus according to claim 1 comprising a housing for housing the pumping means and the sensor.

8. The apparatus according to claim 1 comprising means for controlling both the pumping means and the sensor.

9. The apparatus according to claim 8 comprising a housing for the control means.

10. The apparatus according to claim 1 wherein in use the sensor is sensitive to contaminants in the fluid substantially independent of the pressure of non-contaminants in the fluid.

11. The apparatus according to claim 1 wherein the sensor is arranged to provide an output which is indicative of the partial pressure of the contaminants with the fluid.

12. The apparatus according to claim 1 wherein the sensor is a quartz crystal microbalance sensor.

13. The apparatus according to claim 1 wherein the sensor is a surface acoustic wave sensor.

14. The apparatus according to claim 13 wherein the contaminant to be sensed is a hydrocarbon.

15. The apparatus according to claim 1 wherein the sensor is a solid state electrochemical cell.

16. The apparatus according to claim 15 wherein the contaminant to be sensed is a hydrocarbon.

17. The apparatus according to claims 1 wherein the sensor is a gas-selective capacitative device.

18. The apparatus according to claim 17 wherein the contaminant to be sensed is water vapour.

19. The apparatus according to claim 1 wherein the sensor is provided with temperature modulation.

20. The apparatus according to claim 19 wherein the temperature modulation is substantially of a stepwise form.

21. The apparatus according to claim 19 wherein the temperature modulation is substantially of a saw-tooth form.

22. The apparatus according to claim 19 wherein the temperature modulation is substantially of a ramped-pulsed form.

23. The apparatus according to claim 1 wherein the sensor has a surface coated with material for absorbing one or more of the contaminants.

24. The apparatus according to claim 1 comprising means for cooling the sensor to a temperature below ambient temperature.

25. The apparatus according to claim 1 comprising a backing pump connected to the outlet for pumping fluid exhaust from the pumping means.

26. The apparatus according to claim 1 wherein the inlet is in fluid communication with a vacuum chamber for receiving fluid therefrom.

27. The apparatus according to claim 1 wherein the contaminants comprise at least one of water and a hydrocarbon.

28. In combination, a vacuum pump having an inlet for receiving fluid and an outlet for exhausting pumped fluid, and a sensor, in fluid communication with a location intermediate the inlet and the outlet, for receiving at least part of the fluid received by the pump and for detecting the presence of one or more contaminants therein.

29. A method of detecting the presence of one or more contaminants within pumped fluid, comprising the steps of:
receiving fluid at an inlet of a vacuum pump; and
conveying from a location intermediate the inlet and an outlet of the vacuum pump, at least part of the fluid received by the pump to a sensor for detecting the presence of one or more contaminants therein.

30. A method of detecting the presence of one or more contaminants within pumped fluid comprising the steps of:
receiving fluid at a first pumping stage; and
conveying from the first pumping stage a first stream of pumped fluid to a second pumping stage and a second stream of fluid to a sensor for detecting the presence of one or more contaminants therein.
